(19) United States
(12) Patent Application Publication
(10) Pub. No.: US 2010/0047666 A1
(43) Pub. Date: Feb. 25, 2010

(54) Electrochemical Cell with Shaped Catalytic Electrode Casing

(75) Inventor: James G. Tatsumi, North Ridgeville, OH (US)

Correspondence Address: MICHAEL C. POPHAL;EVEREADY BATTERY COMPANY INC, 25225 DETROIT ROAD, P O BOX 450777, WESTLAKE, OH, 44145, US

(73) Assignee: Eveready Battery Company, Inc.

(21) Appl. No.: 12/197,381

(22) Filed: Aug. 25, 2008

(51) Int. Cl. H01M 2/08

(52) U.S. Cl. 429/35; 29/731

(57) ABSTRACT

An electrochemical cell having a catalytic electrode in electrical contact with a catalytic electrode casing and more particularly to an electrochemical cell having a catalytic electrode casing provided with a feature to improve reliability of electrode-to-casing contact. Methods for forming electrochemical cells having improved reliability with respect to catalytic electrode casing contact are disclosed.

### FIELD OF THE INVENTION

The present invention relates to an electrochemical cell having a catalytic electrode in electrical contact with a catalytic electrode casing and more particularly to an electrochemical cell having a catalytic electrode casing provided with a feature to improve reliability of electrode-to-casing contact. Methods for forming electrochemical cells having improved reliability with respect to catalytic electrode casing contact are disclosed.

### BACKGROUND OF THE INVENTION

Electrochemical cells having various different types of catalytic electrodes are known, and include for example, fuel cells, gas generating cells for example hydrogen and oxygen generating cells, metal-air cells, and electrochemical sensor cells. Non-limiting examples of such cells are found in U.S. Pat. Nos. 5,242,565; 5,308,711; 5,378,562; 5,567,538; 5,707,499; 6,060,196; 6,461,761; 6,602,629; 6,911,278; and 7,001,865; and in International Patent Publication No. WO 00/36677.

An advantage of cells with catalytic electrodes is that they can use one or more active materials that are not contained within cell or battery housings, thereby providing long use time (e.g., discharge capacity) with a cell having a minimum volume. There is an ongoing desire to improve the performance of such electrochemical cells, such as by improving electrical characteristics (e.g., impedance, operating voltage, power output, energy density, discharge capacity, charging efficiency, cycle life and fade), storage characteristics, leakage resistance, cost, environmental impact of waste disposal, and safety in manufacturing.

Approaches to providing electrochemical cells include the following.

U.S. Pat. No. 5,576,117 relates to a flat-type cell comprising cup shaped positive and negative electrode cases, each having a cylindrical part with the negative electrode case being placed inside the positive electrode case with their cylindrical parts facing each other with a gasket in between, wherein the cylindrical part of the negative electrode case has its open edge folded outwardly to form a U-shaped section and its cylindrical part expanded outwardly, so that the inner volume of the negative electrode case is enlarged and the electrical capacity is reportedly improved with decreased self-discharge and electrolyte leakage.

U.S. Pat. No. 5,662,717 relates to electrode cans and metal air electrochemical cells made with the electrode cans. The invention reportedly provides improved structure, and methods for making the outer edge of the closed end of the can at the joiner of the closed end of the can with a sidewall extending from the closed end. A substantially flat portion of the outer surface of the closed end of the can extends outwardly of the inner surface of the sidewall. The electrochemical cells are reportedly assembled using improved assembly methods. Button-type electrochemical cells made using the invention are reportedly free of the inward dishing common to especially cathode cans in such button cells.

U.S. Pat. Nos. 5,846,672 and 6,183,902 relate to a miniature galvanic cell employing a cell housing comprising an indented cup, such as a beaded cup, and can, wherein the indented area is disposed at the vicinity of the open end of the cup so that effectively the majority of the cross-section thickness of the vertical portion of the cell is attributed to the thickness of the wall of the cup reportedly so that maximum internal volume of the cell is reserved for the active components. A process for producing the housing is also disclosed.

U.S. Pat. No. 5,919,586 pertains to electrochemical cells and anode cans used therein, wherein edge regions of respective anode cans are toed-in. Generally, the first side wall follows a path from an intermediate element of the first side wall to a bottom edge of the first side wall, and a reverse curl extending from the bottom edge toward the top wall. The cathode can have a bottom wall, and a second side wall extending upwardly from the bottom wall. A seal is disposed between the anode can and the cathode can.

U.S. Pat. No. 6,066,184 relates to a voltaic cell, especially in the form of a button cell, with a metal housing sealed liquid-tight including a cell cup and a cell lid electrically insulated against it by a seal, the seal is formed from a sealing part produced by deep drawing from a plastic film. This sealing part is shrink-fitted onto the edge of the cell lid. To produce the voltaic cell, a sealing part is formed by deep drawing from a plastic film, which sealing part is subsequently placed on the edge of the cell lid, shrink-fitted onto the edge of the cell lid and the cell cup is flanged around it.

U.S. Pat. No. 6,232,007 relates to a metal-air battery including (a) an anode, (b) a cathode, (c) a separator between the anode and the cathode, and (d) a container having a louver.

U.S. Pat. No. 6,436,156 relates to a zinc/air button cell having an adhesive sealant applied to a portion of the inside surface of the cell's cathode casing. The adhesive sealant can reportedly be applied to the inside surface of a recessed annular step surrounding the cell's positive terminal on the cathode casing.

U.S. Pat. No. 7,001,689 relates to a zinc/air cell having a thin walled cup shaped anode casing and cathode casing. The cell may be a button cell having an anode comprising zinc and a cathode, which may be catalytic, comprising manganese dioxide. A tight interference fit is reportedly achieved with the outside diameter of the anode casing plus insulating seal thereon being preferably between about 2 and 4.5 mil (0.0508 and 0.114 mm) greater than the inside diameter of the cathode casing. This reportedly reduces the tendency of the casing side walls to spring back after crimping.

U.S. Publication No. 2002/0127467 relates to a non-aqueous electrolyte secondary battery reportedly capable of being assembled by reflow soldering. The assembled non-aqueous electrolyte secondary battery is heat-treated following the temperature-time profile close to that for the reflow soldering, and then provided with the terminals by welding.

U.S. Publication No. 2004/0197645 relates to a zinc/air cell having a thin walled cup shaped anode casing and cathode casing. The cell may be a button cell having an anode comprising zinc and a cathode disk, which may be catalytic, comprising manganese dioxide. The cathode disk is inserted and then punched into the cathode casing so that the disk is pressed towards the closed end of the cathode casing. This reportedly causes the cathode disk to expand radially between the cathode disk and inside surface of the cathode casing, reducing the chance of electrolyte leakage around the edge of the cathode disk.

German Patent No. DE3034600 relates to a galvanic element with a reportedly closely sealed casing, consisting of a housing cup and a cover, which are sealed by a plastic sealing against each other.

Japanese Publication No. 55-093667 relates to obtaining thin and small cells reportedly having superior anti-liquid-leak performance and long life by forming the outer peripheral collar part of a cathode cab into flat form and performing glass etching and applying pressure onto said glass etched part by the bent part of the anode can through a resin packing.

International Publication No. WO 2007/062838 relates to a galvanic element, particularly a button cell, comprising a housing that encompasses a housing cup, a housing cover, and a foil seal which reportedly isolates the housing cup relative to the housing cover. The housing cover is provided with a cover bottom, an adjoining cylindrically embodied section, and an edge section that is adjacent to the cylindrically embodied section. The edge of the housing cover is bent inward or outward in the edge section. The invention also relates to a method for producing such a galvanic element.

It has been found that contact between a catalytic electrode current collector and the catalytic electrode casing can vary due to factors such as variability in horizontal placement of the electrode in the casing, variability in dimensions of the current collector and changes in dimensions or shapes of the casing and current collector during the process of closing the cell. This variable contact can lead to some cells having undesirably high impedance values. One approach to providing cells having consistent impedance values involves minimizing any expansion of the cell diameter during the cell closing operation. Other approaches aim to balance parameters of maximum catalytic electrode diameters for good contact and minimum catalytic electrode doming (bowing away from the bottom of the catalytic electrode casing) at crimping to conserve counter-electrode volume and to reduce stress on other layers of the catalytic electrode.

In view thereof, it would be desirable to provide an electrochemical cell having a catalytic electrode, wherein improved performance characteristics are provided; desirable, reproducible impedance values can be attained; and high impedance outliers can be eliminated.

### SUMMARY OF THE INVENTION

In view of the above, an object of the present invention is to provide electrochemical cells, for example button cells and prismatic cells, exhibiting consistent, desirable contact between the catalytic electrode current collector and the catalytic electrode casing.

Still a further object of the invention is to provide an electrochemical cell having enhanced contact between a current collector of a catalytic electrode and a casing of the catalytic electrode, the casing having a contact enhancing feature.

Another object of the invention is to provide electrochemical cells that are less susceptible to having high impedance values upon discharge, the cells having casings provided with an internal projection in contact with a current collector of a catalytic electrode.

Yet another object of the invention is to promote current flow between the catalytic electrode and catalytic electrode casing by providing after the cell is formed, an indentation on the exterior surface of the catalytic electrode casing that forms a projection on an opposed interior surface of the casing laterally adjacent to a peripheral position of the catalytic electrode current collector that is preferably a screen.

A further object of the invention is to provide an electrochemical cell having a catalytic electrode wherein the catalytic electrode casing has a sidewall inner surface with (a) at least two different radii in the case of a button cell or other cell having a substantially cylindrical catalytic electrode casing, wherein the smallest radius adjacent a catalytic electrode is in contact with a portion of the catalytic electrode current collector; or (b) wherein the sidewall inner surface has at least two different horizontal distances adjacent a catalytic electrode measured along a vertical height of the sidewall to a center line of the casing in the case of a square or prismatic cell, wherein the catalytic electrode casing adjacent the shortest distance is in contact with a portion of the catalytic electrode current collector.

Another object of the invention is to provide an electrochemical cell having a catalytic electrode comprising a current collector screen that is in contact with an inwardly beaded area of a catalytic electrode casing sidewall laterally adjacent thereto and further including an impermeable or hydrophobic membrane or both located between the inwardly beaded area and the base of the casing.

Yet another object of the invention is to provide methods for forming an electrochemical cell having a catalytic electrode that is provided with consistent, desirable contact between the catalytic electrode current collector and the catalytic electrode casing. In a preferred embodiment, the method includes providing a finished or constructed cell with beading or an indentation utilizing a blade edge laterally adjacent to the catalytic electrode current collector.

In one aspect of the invention, an electrochemical cell is disclosed comprising a catalytic electrode casing in contact with a catalytic electrode comprising a current collector screen, a counter electrode casing in electrical contact with a counter electrode, an electrolyte, and an insulating seal member disposed between the catalytic electrode casing and the counter electrode casing wherein: the catalytic electrode casing has an open end, an opposing closed end comprising a base having an aperture, and a sidewall extending between the closed end and the open end; the sidewall has an outer surface having an inward indentation relative to a portion of the outer surface both above and below the indentation, and an inner surface having an inward projection relative to a portion of the inner surface both above and below the projection; the catalytic electrode is disposed in the catalytic electrode casing adjacent to the base and has a peripheral edge disposed adjacent the sidewall; and the projection is in contact with the current collector screen at the peripheral edge of the catalytic electrode.

In another aspect of the invention, an electrochemical cell is disclosed comprising a catalytic electrode comprising a current collector screen and at least one membrane layer that is air permeable and electrolyte impermeable, a counter electrode, a separator disposed between the counter electrode and the catalytic electrode; a first casing in electrical contact with the catalytic electrode, said first casing having an open end, a closed end comprising a base having an aperture, and a sidewall extending between the closed end and the open end, said sidewall comprising an inner surface and an outer surface; a second casing in electrical contact with the counter electrode; and an insulating seal member disposed between the first and second casings, wherein the cell is a cylindrical or button cell and the sidewall inner surface has a radii measured from a central vertical axis of the cell including a first radius that is in contact with a peripheral portion of the current collector screen, a second radius below the first radius and adjacent a portion of the at least one membrane layer of the catalytic electrode, a third radius above the first radius and the first radius is smaller than the second radius and the third radius.

In yet another aspect of the invention, an electrochemical cell is disclosed comprising: a catalytic electrode comprising a current collector screen and at least one membrane layer that is air permeable and electrolyte impermeable, a counter electrode, a separator disposed between the counter electrode and the catalytic electrode, a first casing in electrical contact with the catalytic electrode, said first casing having an open end, a closed end comprising a base having an aperture, and a sidewall extending between the closed end and the open end, said sidewall comprising an inner surface and an outer surface, a second casing in electrical contact with the counter electrode, and an insulating seal member disposed between the first and second casings, wherein the sidewall has an area beaded inwardly relative to the sidewall above and below the beaded area, the beaded area is adjacent to and contacting an edge of the current collector screen, and a portion of the at least one membrane layer of the catalytic electrode is located closer to the first casing base than the current collector screen.

In still another aspect of the invention, a method for improving electrode to casing contact is disclosed, comprising the steps of providing an electrochemical cell having a positive casing having an open end, a closed end comprising a base, and a sidewall extending between the closed end and the open end, disposing a catalytic electrode in the catalytic electrode casing, the catalytic electrode comprising a current collector screen having a major surface extending substantially perpendicular to the sidewall, and forming an indentation in an outer surface of the sidewall laterally adjacent the current collector screen of the catalytic electrode that creates a projection on an inner surface of the sidewall that contacts the current collector screen.

The present invention achieves these and other objectives which will become apparent from the description that follows.

### BRIEF DESCRIPTION OF THE DRAWINGS

The invention will be better understood and other features and advantages will become apparent by reading the detailed description of the invention, taken together with the drawings, wherein:

FIG. 1 is an elevational view, in cross-section, of a button-type electrochemical cell having a catalytic electrode, with the catalytic electrode casing having a sidewall with an indentation and a corresponding inner surface having a projection in contact with a portion of the catalytic electrode current collector screen;

FIG. 2 is an enlarged elevational, cross-sectional view of the lower right-hand corn er of the view shown in FIG. 1, particularly illustrating the catalytic electrode casing having a sidewall with an indentation and the corresponding inner surface having a projection;

FIG. 3 is an elevational view, in cross-section, of a prismatic-type electrochemical cell having a catalytic electrode casing provided with a groove in the casing adjacent the catalytic electrode current collector;

FIG. 4 is an elevational view, in cross-section, of a button-type electrochemical cell positive electrode casing having a stepped base, wherein a positive electrode is shown in the casing;

FIG. 5 is a chart illustrating 40 Hz impedance values for cells not including any catalytic electrode casing sidewall beading;

FIG. 6 is a chart illustrating 40 Hz impedance values for cells including a catalytic electrode casing sidewall beading; and

FIG. 7 is a graph defining results from a high drain simulation test.

### DETAILED DESCRIPTION OF THE INVENTION

The present invention relates to electrochemical cells including a catalytic electrode having a catalytic electrode current collector that provides an electrical path to a catalytic electrode casing that is in contact with the catalytic electrode current collector. As further described hereinbelow, the catalytic electrode, as referred to herein, can be a fluid depolarized electrode such as an air electrode or a gas generating electrode. Electrochemical cells of the invention can include button-type cells, cylindrical cells, flat cells and prismatic cells. Button-type cells are generally cylindrical in shape and have maximum diameters that are greater than their total heights. Likewise, cylindrical cells can have maximum diameters that are less than their total heights. Flat cells or prismatic cells are typically rectangular in shape, but are not limited thereto, and can be square and have a length substantially equal to a width of the cell or otherwise be non-cylindrical in shape. Preferred cell types include metal-air cells, such as zinc-air cells that contain zinc as a negative or counter electrode active material and utilize oxygen from the surrounding atmosphere as a positive or catalytic electrode active material.

Electrochemical cells that are gas generating cells produce gas by oxidation or reduction at the catalytic electrode. Examples of gasses capable of being generated by the gas generating catalytic electrode include oxygen and hydrogen. For example, a gas generating cell can be provided, such as an alkaline cell having a counter electrode comprising a metal oxide, wherein, when current is forced to flow through the cell, the metal oxide is reduced to a lower oxidation state or the corresponding metal, and oxygen is evolved at the gas generating electrode. In the case of an embodiment of a hydrogen generating cell wherein hydrogen is evolved from the gas generating electrode, such as in an alkaline cell, oxygen is excluded from the gas generating electrode and hydrogen gas is generated within the gas generating electrode when an electric current is enabled to flow through the cell. Further explanations regarding gas generating cells and gas generating catalytic electrodes, and materials therefore, are set forth in U.S. Pat. Nos. 5,242,565; 5,707,499 and 6,060,196, herein fully incorporated by reference.

Button cells are generally cylindrical in shape and have maximum diameters that are greater than their total heights. The maximum diameter is generally between about 4 mm to about 35 mm, desirably from about 5 mm to about 35 mm. Preferably the maximum diameter is no greater than about 30 mm and more preferably no greater than about 20 mm. The button cells have a maximum height or thickness, measured perpendicular to the diameter, generally from about 1 mm to about 20 mm, desirably from about 1 mm to about 15 mm. Preferably the maximum height is no greater than about 10 mm and more preferably no greater than about 8 mm.

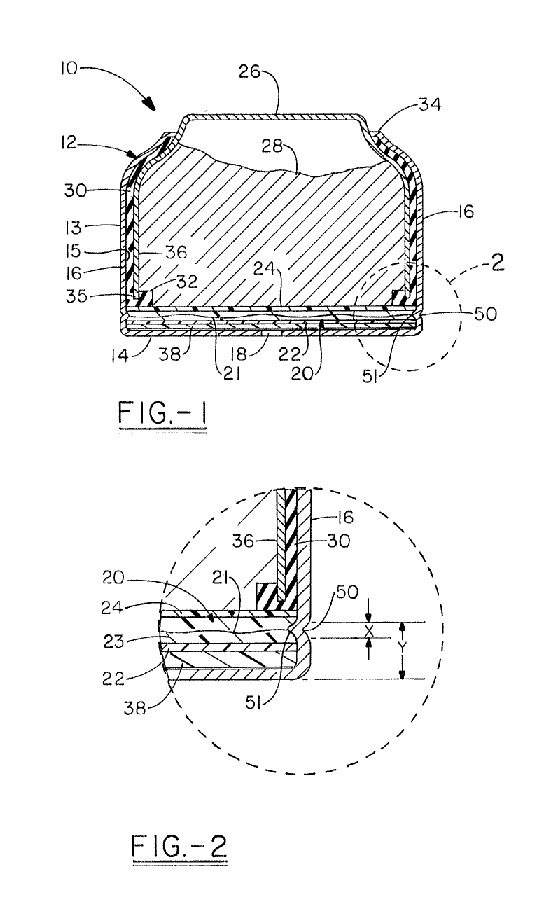

One embodiment of an electrochemical cell having a catalytic electrode is illustrated in FIG. 1. The cell 10 illustrated is a button-type cell, more specifically an air-depolarized cell having a catalytic positive electrode.

In FIG. 1, the cell 10 has a two-part metal housing containing a positive or catalytic electrode 20 and a negative or counter electrode 28, separated by an electrically insulating, ion permeable separator 24. One part of the metal housing, referred to as the catalytic electrode casing or can 12, is in electrical contact with the catalytic electrode 20, and the other part of the housing, referred to as the counter electrode casing or cup 26 is in contact with and serves as the current collector for the counter electrode 28. Between the casing 12 and cup 26 is an electrically insulating seal member, such as a grommet or gasket 30. The rim 34 of the casing 12 is deformed inward and downward against the gasket 30 and cup 26 so that the gasket 30 provides a compression seal between the casing and cup sidewalls 13 and 36, respectively. The gasket 30 has an inward extending base and a lip 32 that form a groove into which the bottom rim 35 of the cup 26 fits. The axial force applied by the bent rim 34 of the casing 12 also creates a seal between the cup bottom rim 35 and the periphery of the inside surface of the casing or base 14. At least one aperture 18 is located in the casing or base 14 through which air containing oxygen used an active material by the catalytic electrode 20 can enter the cell 10. The casing 12 has an inner or interior surface 15 and an outer or exterior surface 16. The catalytic electrode 20 includes a catalytic active layer 23 with a metal screen or expanded metal current collector 21 embedded in the surface facing the separator 24. The catalytic electrode 20 also includes a hydrophobic membrane 22 laminated to the side of the catalytic mixture opposite the separator 24. Located between the hydrophobic membrane 22 and the inside surface of the casing 14 is an optional gas diffusion layer 38.

A gas generating cell can have a construction similar to that of cell 10 in FIG. 1. The catalytic electrode 20 can be either a positive electrode or a negative electrode, and the counter electrode 28 can be either a negative or a positive electrode. In one embodiment of a gas generating cell, the gas diffusion layer 38 can have a high hydrogen permeability and a low oxygen permeability to allow hydrogen gas generated at the catalytic electrode 20 to escape from the cell through the aperture 18 while substantially blocking the entry of air from the external environment. An example of a suitable material for the hydrogen diffusion layer 38 is sintered polytetrafluoroethylene, such as virgin sintered PTFE membrane conforming to ASTM D3308 Type II and SAE AMS 3662C, an example of which is D/W 202 skived PTFE from DeWal Industries, Saunderstown, R.I., USA, 0.051 mm (0.0020 inch) thick and having typical tensile strength of 422 kg/cm² (6000 pounds per square inch), a typical elongation of 325 percent, a typical dielectric strength of 2000 volts, a typical BJH adsorption cumulative pore volume of 0.0004 to 0.0023 cm³/g and a typical density of 2.1 to 2.2 g/cm³.

In some embodiments, a refold counter electrode or negative electrode cup or casing is utilized instead of a straight-walled cup 26 in FIG. 1. As known in the art, refold anode cups have rounded rims that are substantially U-shaped at the ends that define the openings in the counter electrode cup. A refold anode cup is formed in one embodiment by folding a portion of the wall of the cup back upon itself so that the opening in the cup is defined by a folded rim. The refold counter electrode cup can be formed of the materials, dimensions and the like as described herein with respect to cup 26.

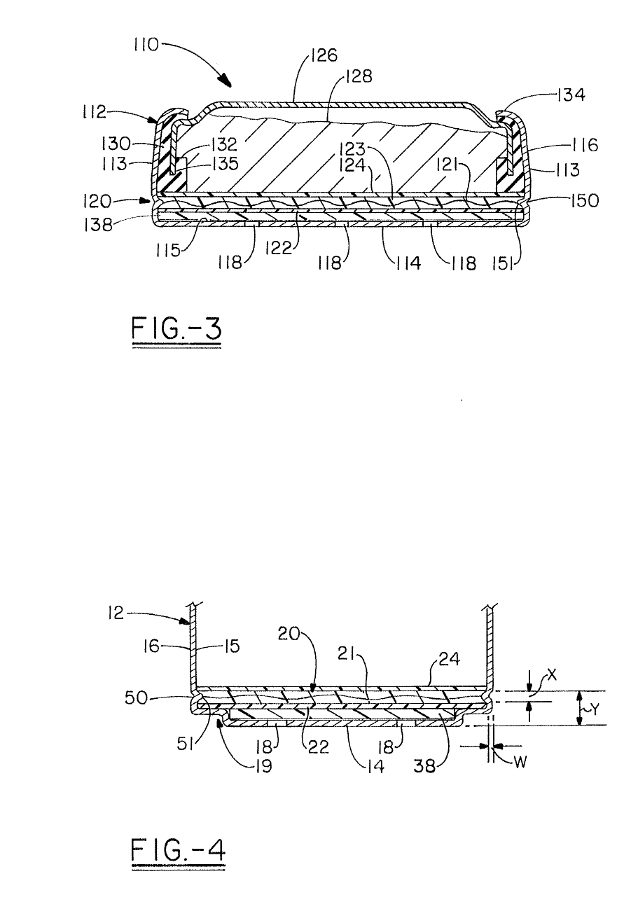

FIG. 3 illustrates one embodiment of a prismatic electrochemical cell 110 including a catalytic electrode casing 112 that is generally prismatic shaped, preferably rectangular and is formed having four linear or non-linear sidewalls 113 connected to a central region or base 114. Base 114 can be planar or can include single or multiple steps, if desired. Catalytic electrode casing 112 has an inner or interior surface 115 and an outer or exterior surface 116. At least one air aperture 118 extends between inner surface 115 and outer surface 116 of casing 112, preferably in base 114 to admit a fluid, i.e., air into cell 110. In one embodiment, cell 110 includes a layer of material 138, preferably a sheet that can be an air permeable, hydrophobic layer or an air and water permeable layer. In one embodiment, layer 138 is one or more loose layers that are not laminated or otherwise connected or bonded to an essential portion of catalytic electrode 120. Examples of suitable materials for loose layer 138 include, but are not limited to, porous paper or fibers when layer 138 is an air distribution layer or an air permeable hydrophobic membrane such as polytetrafluoroethylene (PTFE) when layer 138 is an air diffusion layer. In some preferred embodiments, the peripheral portion of layer 138 can be bonded to the catalytic electrode or the inner surface of casing 112.

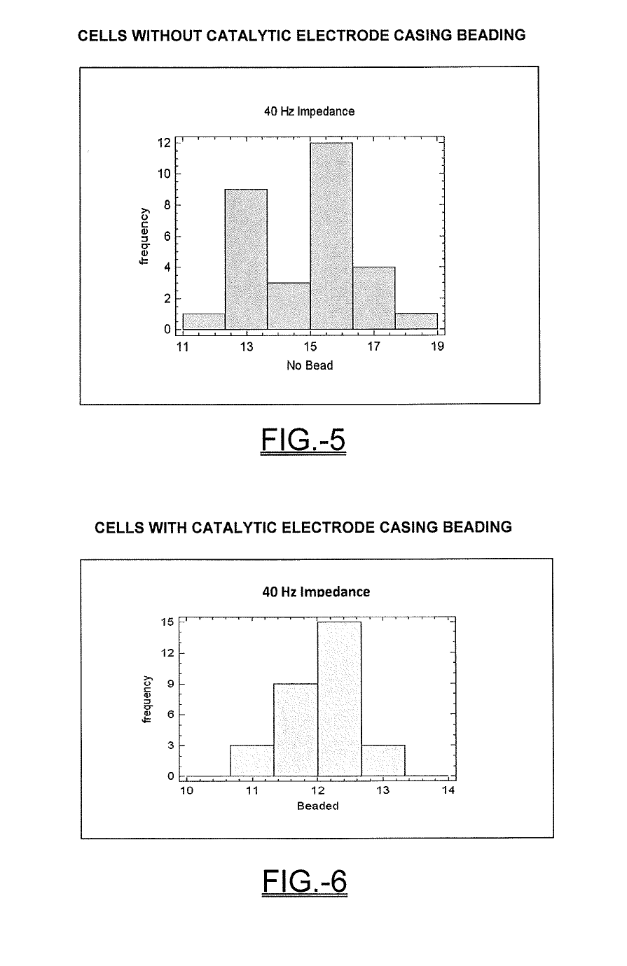

FIG. 4 illustrates a further embodiment of a catalytic electrode casing 12 including a base 14 having a stepped section 19. While a single step-down is illustrated, it is to be understood that the base 14 can include more than one stepped section 19. In the embodiment illustrated, layer 38 has a periphery that is located within the lower portion of the stepped section, which also contains aperture 18. As further explained hereinbelow, the casing 12 includes an indentation 50 and a projection 51 lateral to the indentation 50. The indentation has a depth W, a vertical width X and a maximum height Y measured relative to the maximum depth W.

The catalytic electrode 134 includes a catalytic active layer 123 that may be any material suitable for use as a catalytic electrode, but is preferably a mixture of carbon, manganese oxide (MnOₓ), and a binder such as a tetrafluoroethylene (TFE). A catalytic mixture also optionally contains a surfactant often present in the TFE when blended with the other ingredients of the catalytic layer 135. In one embodiment, the catalytic mixture can include particles of a nano-catalyst adhered to the surfaces of particles of the carbon, as disclosed in U.S. Patent Publication No. 2008/0015813, which is hereby incorporated by reference. Catalytic electrode 134 preferably includes a hydrophobic layer 122 that can be bonded, such as by pressure lamination, on the underside of catalytic electrode 120 and is also fixed to a surface of the active layer 123 and faces at least one air aperture 118. The method of pressure lamination can be a patterned lamination process as disclosed in U.S. Patent Publication No. 2008/0015813. Bonded layer 122 is an air permeable, hydrophobic membrane, preferably PTFE in one embodiment. Catalytic electrode 120 preferably contains a current collector 121 which can be a metal or expanded screen, embedded in catalytic layer 123.

Counter electrode casing or cup (non-cylindrical) 126 forms a second part of the two-part metal housing of cell 110 and contains negative or counter electrode 128. Catalytic electrode 120 and counter electrode 128 are separated by an electrically insulating, ion permeable separator 124. Between casing 112 and cup 126 is an electrically insulating seal member, such as grommet or gasket 130. Gasket 130 has an inwardly extending base and a lip 132 that form a groove into which the bottom rim of the cup 126 fits.

As illustrated in FIGS. 1 and 3, casing 12, 112 forms the bottom of the cell 10, 110. Catalytic electrode casing 12, 112 is generally made from a metal with sufficient mechanical strength with a casing to withstand cell closing and sealing forces and maintain an adequate seal with the gasket 30, 130 and cup 26, 126 even with the internal pressure that may be present in the cell 10, 110 during normal use. The material of the casing 12, 112 also has good electrical conductivity, since the casing serves as an electrical contact terminal for the cell 10, 110. The casing can be formed of one or more, same or different, layers of metal, with examples including, but not limited to nickel, nickel plated steel, stainless steel, and nickel plated stainless steel, with nickel plated steel being preferred. The casing has good corrosion resistance both externally and internally with respect to components with which the casing will come into contact with.

Likewise, the counter electrode casing or cup 26, 126 forms the top of the cell 10, 110 as illustrated in FIGS. 1 and 3. It is made from a metal providing sufficient mechanical strength to withstand cell closing and sealing forces and maintain an adequate seal with the gasket 30, 130 and casing 12, 112. The cup 26, 126 has good electrical conductivity since the cup 26, 126 serves as a current collector for the counter electrode 28, 128. The inner surface has good corrosion resistance to the components in contact therewith and the outer surface of the cup 26, 126 has good corrosion resistance and discoloration resistance in environments in which the cell 10, 110 will be used. In one embodiment, in order to minimize unwanted gas generation where electrolyte comes in contact with the cup 26, 126, the substrate has an essentially continuous layer of copper on the surface forming the inside of the cup 26, 126. In a further embodiment, the cup substrate has an essentially continuous layer of copper on the surface forming the outside of the cup 26, 126 in order to provide a desirable surface onto which a coating can be applied, such as plating.

In a preferred embodiment, the substrate of cup 26, 126 is a clad metal including a layer of copper, preferably on each of the exterior and interior surfaces of the cup substrate. The clad copper layer provides a continuous layer of copper. The copper layer is advantageous for a number of reasons. It has a relatively high hydrogen overvoltage, so if the copper-tin-zinc alloy plating is not continuous or is damaged during cell manufacturing, electrolyte will not be in direct contact with a high gassing, low hydrogen overvoltage metal. Copper is also relatively ductile, substantially preventing the risk of cracking during the cup forming process to expose the lower hydrogen overvoltage metal layer beneath it. A clad material is preferred because the copper layer is continuous, and the composition of the layer to which it is clad can be selected to provide the required strength to the substrate. Preferably the copper layer is clad to a layer of steel, such as a mild steel, a cold rolled steel or, more preferably, a stainless steel. The substrate material can be a biclad material, or it can have three or more layers, such as a triclad material. The relative thicknesses of the layers and the total thickness of the substrate material can be selected to provide the best combination of strength, gassing resistance and corrosion resistance, based on the cell size and ingredients. A preferred triclad material is a copper-stainless steel-copper triclad material.

In one embodiment, at least the outer surface of cup 26, 126 is provided with a copper-tin-zinc alloy. Examples of suitable counter electrode cups are described in U.S. Publication Nos. 2007/0283558 and 2008/0102360, and U.S. patent application Ser. No. 12/109,419, all fully incorporated herein by reference.

The seal member such as gasket 30, 130 is made from an elastomeric material which provides a compressive seal for the cell 10, 110. Examples of suitable elastomeric materials include nylons. Optionally, a sealant may be applied to sealing surfaces of the gasket 30, 130, cup and/or can. Suitable sealant materials will be recognized by one skilled in the art. Examples include asphalt, either alone or in combination with elastomeric materials or ethylene vinyl acetate, aliphatic or fatty polyamides; and thermoplastics or thermoplastic elastomers such as polyolefins, polyamine, polyethylene, polypropylene and polyisobutene. A preferred sealant is SWIFT® 82996, from Foxboro Adhesives, LLC, of Research Triangle Park, N.C., USA. As an alternative to a molded gasket 30, 130, an electrically nonconductive adhesive can be used to seal the inner surface of the can side wall 13, 113 to the outer surface of the cup side wall 36, 136. As used herein, the cup surface area exposed to the negative or counter electrode is that portion of the internal surface of the cup that is not covered by the gasket or adhesive and could come in contact with the negative or counter electrode and/or electrolyte.

The counter or negative electrode 28, 128 in one embodiment contains zinc as an active material and an aqueous alkaline electrolyte. The zinc is a low-gassing zinc. Examples of low gassing zincs are disclosed in U.S. Pat. Nos. 6,602,629 and 5,464,709; and U.S. Patent Publication No. 2005/0106461 A1, which are hereby incorporated by reference.

A preferred zinc, as disclosed in U.S. Patent Publication No. 2005/0106461 A1, is a zinc alloy powder containing bismuth, indium and aluminum, preferably about 100±25 parts per million by weight (ppm) of bismuth, about 200±30 ppm of indium and about 100 ±25 ppm of aluminum. The alloy preferably contains about 35+10 ppm of lead. The preferred average particle size (D₅₀) for metal-air cells is less than 130 microns, more preferably about 90 to about 120 microns. Preferred characteristics of the alloy include a tap density greater than 2.80 g/cc and less than 3.65 g/cc, a BET specific surface area greater than 400 cm²/g, and a KOH absorption value of at least 14 percent. Examples of preferred zinc powders for metal-air cells are product grades NGBIA 100, NGBIA 110 and NGBIA 115, manufactured by N.V. Umicore, S.A., Brussels, Belgium, most preferably NGBIA 115. A preferred zinc powder for zinc/metal oxide or dioxide cells such as zinc/silver oxide cells is BIA, also available from N.V. Umicore. The electrolyte can include potassium hydroxide. In some embodiments, sodium hydroxide can replace all or part of the potassium hydroxide.

The counter or negative electrode 28, 128 is preferably a gelled electrode, using a binder or gelling agent. Examples of suitable gelling agents for metal-air cells include acrylic acid polymers in the 100% acid form, such as CARBOPOL® 940 and CARBOPOL® 934 from Noveon Inc. of Cleveland, Ohio, USA, and a crosslinked sodium polyacrylate, such as SANFRESH™ DK-300 and DK-500 MPS from Tomen America, New York, N.Y., USA. SANFRESH™ DK-300 is preferred. Examples of suitable gelling agents for zinc/metal oxide cells include carboxymethyl cellulose (CMC) from Hercules of Wilmington, Del., USA and a modified CMC available from FMC Corporation of Philadelphia, Pa. (USA) as AC-DI-SOL®.

The counter electrode 28, 128 can contain other ingredients, to reduce gassing or to improve cell performance, for instance. Examples include zinc oxide, indium hydroxide, and one or more surfactants. A preferred surfactant for both metal-air cells and zinc/metal oxide cells is an anionic polymer surfactant, such as DISPERBYK® D102 and D190 from Byk Chemie of Wallingford, Conn., USA.

The catalytic electrode 20, 120 has a layer of a catalytic mixture. The mixture can include carbon, such as PWA carbon from Calgon Corp., Pittsburgh, Pa., USA, or DARCO® G60 carbon from American Norit Co., Inc., Marshall, Tex., USA, and a catalytic material, such as a manganese oxide, held together by a binder, such as a polytetrafluoro-ethylene resin. The catalytic material is optional for a hydrogen generating cell but is required for an oxygen generating cell and a zinc-air battery cell. This layer is somewhat porous to allow the mixture to be wetted by electrolyte. Water in the catalytic electrode 20, 120 reacts to produce hydrogen gas in a hydrogen generating cell.

The electrically conductive current collector 21, 121 of the catalytic electrode is typically a metal screen or expanded metal, such as nickel or a nickel plated or clad iron or steel. A preferred current collector material, particularly for small cells such as button cells, is an expandable metal (e.g., nickel EXMET™ from Dexmet Corp., Naugatuck, Conn., USA), preferably one with a base metal thickness from 0.05 to 0.127 and more preferably from 0.06 to 0.08 mm. The expanded nickel material is preferably equivalent to a 40 mesh (40 openings per inch) screen. Another preferred current collector material, particularly for cells larger than button cells, is a woven wire cloth with cross-bonded wires (wires welded where they cross), preferably 40 to 50 mesh (40 to 50 openings per inch) with a wire diameter of 0.10 to 0.15 mm (available from Gerard Daniel Worldwide, Fontana, Calif., USA). The surface of the current collector can be treated by acid etching, such as with nitric acid, to roughen the metal surfaces. Alternatively, the current collector can be coated with a carbon containing material, such as a graphite coating. Examples of suitable graphite coating materials include: TIMREX® LB1000, LB1016 and LB1090 aqueous graphite dispersions (TIMCAL America, Westlake, Ohio, USA), ECCOCOAT® 257 (W.R. Grace & Co.), and ELECTRODAG® 109 and 112 and EB0005 (Acheson Industries, Port Huron, Mich., USA).

The hydrophobic catalytic membrane 22, 122 laminated to the catalytic layer provides a barrier to water loss from the cell or water gain into the cell. It will have sufficient strength to withstand the electrode lamination process and forces applied during cell closing, and it will be stable when in contact with the electrolyte. Polytetrafluoroethylene film is an example of a suitable material.

A sealant such as a thermoplastic hot melt adhesive, for example SWIFT® 82996 from Forbo Adhesives, LLC of Research Triangle Park, N.C., USA, can be used to bond peripheral portions of the catalytic electrode 20, 120 (particularly hydrophobic catalytic membrane 22, 122) and the diffusion layer 38, 138 together and/or to bond the peripheral portion of the diffusion layer 38, 138 to the peripheral portion of the casing 12, 112 to provide an improved cell seal.

The separator 24, 124 is electrically nonconductive and ion permeable to electrically insulate the catalytic electrode 20, 120 from the counter electrode 28, 128, while allowing ions to pass through. The separator 24, 124 can include one or more layers, and the layers can be the same or different materials. A preferred separator 24, 124 has two layers, one an air-permeable, water-wettable nonwoven polypropylene film treated with surfactant, such as CELGARD® 5550, from Celgard, Inc., Charlotte, N.C., USA, next to the counter electrode 28, 128, and the other a hydrophobic polypropylene membrane, such as CELGARD® 3501, against the catalytic electrode 20, 120. The layers of separator 24, 124 are preferably adhered to the catalytic electrode 20, 120 and each other with an adhesive, such as a blend of carboxymethylcellulose and polyvinyl alcohol (9 to 1 by weight). In an embodiment where the catalytic electrode includes one or more of silver oxide and manganese dioxide, the separator is preferably a laminated material with layers of cellophane and polyethylene. In a cell with a catalytic electrode 20, 120 comprising silver oxide, the separator 24, 124 is resistant to silver ions. In such cells, the separator 24, 124 can include a barrier layer such as a polyethylene/cellophane laminate impervious to silver ions but not hydroxyl ions and a soak-up layer made from a material such as cellulose or polyvinyl alcohol that will retain electrolyte solution and allow hydroxyl ions to pass between the catalytic and counter electrodes 20, 120 and 28, 128.

During manufacture of the cell 10, 110, the cup 26, 126 is preferably inverted, and the components of the counter electrode 28, 128 are put into the cup 26, 126. The components can be inserted in a two step process wherein dry materials (e.g., the zinc, binder and In(OH)₃) are dispensed first, followed by the electrolyte solution, which can include aqueous KOH solution, surfactant and zinc oxide, for example. Alternatively, the wet and dry components can be blended beforehand and then dispensed or extruded in one step into cup 26, 126. The gasket 30, 130 is then placed over the cup rim 35, 135.

The diffusion layer 38, 138 when present, catalytic electrode 20, 120 and separator 24, 124 are inserted into the catalytic electrode casing 12, 112, preferably with an interference fit between the peripheral edge of the current collector 21, 121 and the casing 12, 112. The casing 12, 112 is then inverted, and the casing 12, 112, catalytic electrode 20, 120 and separator 24, 124 are pressed against the cup/gasket assembly. The casing rim 34, 134 is deformed inwardly, so it is compressed against the gasket 30, 130, thereby sealing the cell components within the cell housing.

Any suitable method may be used to deform the edge of the casing inward to seal the cell, including crimping, colleting, swaging, redrawing, and combinations thereof as appropriate. Preferably the button cell is sealed by crimping or colleting with a segmented die so that the cell can be easily removed from the die while a better seal is produced. As used herein, a segmented die is a die whose forming surfaces comprise segments that may be spread apart to enlarge the opening into/from which the cell being closed is inserted and removed. Preferably portions of the segments are joined or held together so they are not free floating, in order to prevent individual segments from moving independently and either damaging the cell or interfering with its insertion or removal. Preferred crimping mechanisms and processes are disclosed in commonly owned U.S. Pat. No. 6,256,853, which is hereby incorporated by reference.

After a cell 10, 110 is assembled, a suitable tab or adhesive tape (not shown) can be placed over the one or more apertures 18, 118, when present in the casing base 14, 114 until the cell 10, 110 is ready for use.

The assembled, completed electrochemical cell is further processed to improve contact reliability between the catalytic electrode current collector 21, 121 and the catalytic electrode casing 12, 112. More specifically, an indentation 50, 150 is formed on outer surface 16, 116 of sidewall 13, 113 of the catalytic electrode casing 12, 112. The process used to form indentation 50, 150 also results in forming a projection 51, 151 on the inner surface 15, 115 of the sidewall 13, 113 adjacent the indentation 50, 150 and also adjacent the catalytic electrode current collector 21, 121.

The indentation is characterized by an inwardly projecting feature having a desired spacing from the margins of the adjacent outer surfaces of the cell casing, on either side of the indentation. The indentation can be present in many different forms. For example, the indentation can be a groove, depression, recess, a trough, or the like in the sidewall 13, 113 of the catalytic electrode casing 12, 112. The indentation can be continuous or discontinuous around the perimeter of the sidewall of the casing. The indentation can be formed having a variety of shapes or forms such as a portion or segment of a circle, arc, square, triangle, rectangle, or other shape. In one embodiment for example, the indentation extends completely around the periphery of the outer surface of the sidewall of the catalytic electrode casing without interruption or having any gaps. Preferably, the continuous indentation 50, 150 is in planar form, adjacent the catalytic electrode current collector 21, 121 to provide for a desirable contact between the sidewall projection 51, 151 formed by imparting the indentation to the sidewall, and the catalytic electrode current collector perimeter. In a further embodiment, discontinuous indentations are formed of two or more interrupted segments. Discontinuous indentations 50, 150, and thus projections 51, 151 as well, can be present in substantially any form and separated by spaces or gaps of any length that can be random or incremental. Each indentation or projection, independently, can be longer or shorter in distance than a gap. For button and other round cells, a continuous indentation is preferred. For discontinuous indentations, a pattern that extends around the entire circumference avoids orientation of the indentation with the current collector in situations where contact reliability can vary in different portions of the edge of the current collector. The pattern (e.g., size, shape and location of indentations, percentage of the circumference that is indented, etc., should be selected to insure reliable contact results; the pattern selected can depend in part on the design of the current collector and whether or not contact reliability is uniform around the periphery of the current collector. In one embodiment of a prismatic cell, indentations are formed along a length of two out of the four sides of the cell, generally from about 50% to 100% of the length of a side. Preferably the indentation will be centered on the side. Preferably the full length or nearly the full length of the straight portion of the side (i.e., excluding at least part of the corner portions) is indented. In an embodiment, two opposite sides are indented. In general, the likelihood of poor contact reliability can be greater along long sides of the cell. When this is the case, one or both long sides are preferably indented.

The size, depth and location of the indentations and corresponding projections are important parameters of the invention. As indicated, the location of the one or more indentations is lateral to the outer periphery of the catalytic electrode current collector after axial compression of the catalytic electrode casing upon closing of the cell. The vertical (e.g., axial) height of the indentation, generally measured perpendicular to the plane of the outer surface of the base of the catalytic electrode casing, is sufficient to produce desired contact of the projection with the catalytic electrode current collector and cause minimal disturbance to the components of the cell, such seal as a seal member or other layers of the catalytic electrode, such as a hydrophobic catalytic membrane or other membrane. The vertical height of the indentation should be such that the deepest projection on the inside of the casing is aligned with at least a portion of the adjacent portion of the edge of the current collector after the cell is closed. The vertical height of the indentation at a given point on the perimeter of the cell is the distance from the outer surface of the casing bottom just radially inward from the rounded outer corner of the casing and the vertical midpoint of the deepest portion of the indentation in the external surface of the casing side wall (dimension Y in FIGS. 2 and 4). The vertical width of the indentation, see dimension X in FIGS. 2 and 4, is preferably sufficient to provide this given the variability in the vertical position of the current collector edge. To minimize doming of the catalytic electrode, it is desirable that the vertical width of the indentation is no greater than necessary to provide contact reliability, thus an indentation/projection relative to the surface of the can wall both above and below the indention/projection is desired, rather than reducing the diameter or width of the entire lower portion of the can side wall for example. For example, in one embodiment of a button cell, the indentation covers a width at a vertical height between 0.254 mm (0.010 inch) and 0.508 mm (0.020 inch) from the outer surface of the base of the catalytic electrode casing.

The inwardly extending depth of the projection measured generally in a horizontal direction, such as illustrated in FIG. 1, and parallel to a plane of the base of the cell should be sufficient to establish good contact between the projection on the inner surface of the sidewall and the current collector of the catalytic electrode. The depth of the projection should not exceed a depth where one or more of the base and the casing is deflected, the casing sidewall is comprised or detrimental catalytic electrode deformation occurs. The maximum depth of the indentation is measured from the outer surface of the casing as the greatest horizontal distance (i.e., the radial distance in a cylindrical cell) between the greatest inwardly or radially extending external surface portion of the indentation and a point located on the side wall of the casing just above or below the indentation (dimension W as shown in FIG. 4). The maximum depth should be sufficient to provide good electrical contact but otherwise minimized to minimize doming of the catalytic electrode. For example, cells with catalytic casing thicknesses ranging from about 0.10 mm (0.004 inch) to about 0.25 mm (0.010 inch), the maximum depth ranges generally from about 0.0127 mm (0.0005 inch) to about 0.0762 mm (0.003 inch). Preferably the maximum depth of the indentation will be no more than about 0.0508 mm (0.002 in.). If the indentation is too deep, the casing can crack or the catalytic electrode can bend excessively away from the catalytic electrode casing bottom. Preferably the maximum depth will be at least about 0.0254 mm (0.001 in.). If the indentation is too shallow, the improvement in reliability of electrical contact with the catalytic electrode current collector will be less than desired.

Various methods can be utilized to form the one or more indentations and corresponding projections in the finished electrochemical cell. In each of the methods, the location of the catalytic electrode current collector 21, 121, more specifically the periphery or perimeter of the current collector, in the closed cell is determined. The determination can be made by any method, such as by calculation of dimensions of the cell components, post cell closing, such as the thickness of various layers of the catalytic electrode 20, 120 such as the thickness of the catalytic electrode casing base 14, 114, and any layer(s) located between the base 14, 114 and the current collector 21, 121, for example a loose layer 38, 138 or a catalytic membrane 22, 122. Alternatively, one or more closed cells can be autopsied to determine a relative location of the catalytic electrode casing 21, 121 within the cell.

After determination of the location of the catalytic electrode current collector 21, 121 within the cell 10, 110 has been made, the one or more indentations 50, 150 are formed in the outer surface 16, 116 of sidewall 13, 113 causing one or more adjacent projections 51, 151 to be formed on the inner surface 15, 115, such as illustrated in FIGS. 1-3. The one or more indentations are created in one embodiment with a forming tool such as a blade having an edge shaped to form an indentation having a desired contour such as described hereinabove. That is, by way of non-limiting example, the blade edge for example can have a shape that is rounded, archial, squared, triangular, or other shape. The forming tool blade edge is contacted with the desired area on the catalytic electrode casing 12, 112 to form the indentation 50, 150 and corresponding projection 51, 151. The blade edge is brought in contact with the casing side wall at a location adjacent to the periphery of the catalytic electrode current collector and one or more indentations formed. Two or more indentations can be selectively formed by discontinuous contact between the casing 12, 112 and the blade edge. The projection formed adjacent the indentation on the inner surface of sidewall 13, 113 contacts the catalytic electrode current collector. The blade edge can be stationary or moveable (e.g., rotatable). In an embodiment with respect to button and cylindrical cells, in order to form an indentation, the respective cell is rotated around its vertical axis 11 while being supported, preferably on the bottom of the cell while being held from above against the bottom support. In an embodiment with respect to a prismatic cell, the cell can be rotated about its vertical axis, pushed against a single blade edge, or pushed between two opposing blade edges.

The indentation(s) formed in the catalytic electrode casing improve(s) contact reliability between the casing and the catalytic electrode through the current collector screen. The one or more indentations are formed in a selected area and reduction of the diameter of the whole catalytic electrode casing adjacent the sidewall is prevented, which in some embodiments can cause doming. The contact between the projection of a casing and a catalytic electrode current collector substantially reduces cells having high impedance values during use.

### EXAMPLES

### Example 1

PR41 type zinc-air cells were tested for impedance. First, thirty cells were tested after assembly, but prior to having any post-cell closing indentations placed in the positive air electrode casing laterally adjacent the positive electrode current collector to establish desirable contact between the casing and the current collector. The impedance values were measured at 40 Hz. The results are set forth in FIG. 5.

After the impedances of the cells were measured, an indentation in the form of a radial bead was applied to the test cells and the impedance of the cells was re-measured.

The indentations were formed on each cell as follows. A cell was placed in a position between a push rod and a mandrel, which were shaped according to the cell geometry in order to avoid deformation of the cell. The sidewall area to be indented remained exposed. The mandrel was rotated and a beaded wheel was moved horizontally into the area of the cell to be indented. The beaded wheel controlled the shape and width of the beaded indentation. A 0.076 mm (0.003 inch) radius was present on the edge of the beading wheel. The beading wheel created a 0.076 mm (0.003 inch) radius indentation into the outer surface of the casing sidewall. The casing sidewall in the embodiment had a thickness of 0.152 mm (0.006 inch), and an internal 0.229 mm (0.009 inch) radius was formed on an inner surface of the casing sidewall which was pressed into the electrode adjacent the current collector which was formed from an expanded metal screen. The results of the impedance tests conducted on the cells having the indentations are set forth in FIG. 6.

The results presented in FIGS. 5 and 6 clearly show a reduction in cell impedance variability produced by the formation of the indentation on the outer surface of the cells which produced the internal projection providing desirable contact between the cell casing and the current collector of the positive air electrode.

### Example 2

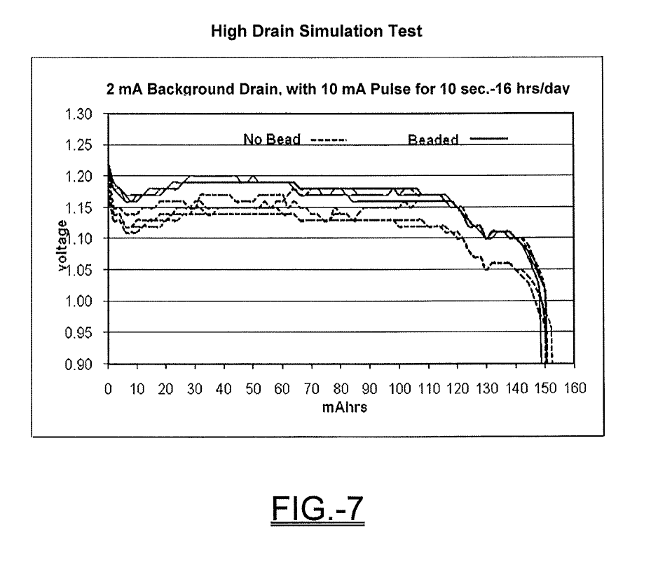

Four PR41 type zinc-air cells constructed as described for Example 1 and four PR41 type zinc-air cells having an indentation and projection, i.e., beaded cells, as described hereinabove for Example 1 were tested to determine if impedance variability could be reduced by a bead application of the present invention which forms the noted indentation and projection on the catalytic electrode casing sidewall adjacent the current collector screen of the catalytic electrode. Testing on the eight (8) cells was conducted using a Widex Battery Test System obtained from Widex A/S of Verlose, Denmark. An IEC type test regimen was utilized that simulated the power requirements of high drain hearing aids, wherein the test cells were subjected to a 2 mA background drain and additionally, a 10 mA pulse for 10 seconds every 16 hours a day. The discharge curves for the cells are set forth in FIG. 7. As indicated in the chart, the dashed lines represent the four cells not having any bead or indentations placed in the catalytic electrode casing sidewall and the solid lines represent cells that included beading of the present invention as described hereinabove.

As indicated in FIG. 7, only one of the cells with the non-beaded catalytic electrode sidewall exhibited adequate current collector-to-casing contact. To the contrary, voltage variability associated with poor contact between the catalytic electrode current collector and the catalytic electrode casing was eliminated in all four cells including catalytic electrode casing sidewall beading.

It will be understood by those who practice the invention and those skilled in the art that various modifications and improvements may be made to the invention without departing from the spirit of the disclosed concept. The scope of protection afforded is to be determined by the claims and by the breadth of interpretation allowed by law.

What is claimed is:

1. An electrochemical cell, comprising a catalytic electrode casing in contact with a catalytic electrode comprising a current collector screen, a counter electrode casing in electrical contact with a counter electrode, an electrolyte, and an insulating seal member disposed between the catalytic electrode casing and the counter electrode casing wherein:
the catalytic electrode casing has an open end, an opposing closed end comprising a base having an aperture, and a sidewall extending between the closed end and the open end;
the sidewall has an outer surface having an inward indentation relative to a portion of the outer surface both above and below the indentation and an inner surface having an inward projection relative to a portion of the inner surface both above and below the projection;
the catalytic electrode is disposed in the catalytic electrode casing adjacent to the base and has a peripheral edge disposed adjacent the sidewall; and
the projection is in contact with the current collector screen at the peripheral edge of the catalytic electrode.

2. The electrochemical cell according to claim 1, wherein the cell comprises at least one layer of air permeable, electrolyte impermeable material disposed between the catalytic electrode and an inner surface of the base.

3. The electrochemical cell according to claim 2, wherein the at least one layer of air permeable, electrolyte impermeable material has a peripheral edge located vertically between the catalytic electrode casing base and a portion of the sidewall projection.

4. The electrochemical cell according to claim 1, wherein the cell is a cylindrical cell or button cell, wherein the catalytic electrode casing sidewall inner surface has at least two different radii adjacent the peripheral edge of the catalytic electrode, and wherein the smallest radius is in contact with a portion of the catalytic electrode current collector screen.

5. The electrochemical cell according to claim 1, wherein the cell is a non-cylindrical cell or a prismatic cell, wherein an inwardmost portion of the catalytic electrode casing projection is in contact with the catalytic electrode current collector screen.

6. The electrochemical cell according to claim 1, wherein the indentation is a continuous indentation that extends around a periphery of the catalytic electrode casing in a plane also containing at least a portion of the catalytic electrode current collector screen.

7. The electrochemical cell according to claim 1, wherein the indentation is two or more segments separated by at least one gap, with the two or more indentations located in a plane also containing at least a portion of the catalytic electrode current collector screen.

8. The electrochemical cell according to claim 1, wherein the cell is a button cell, and wherein a maximum vertical height of the indentation on the catalytic electrode casing sidewall is such that the deepest portion of the projection on the inner surface of the catalytic electrode casing sidewall is aligned with at least a portion of the current collector screen.

9. The electrochemical cell according to claim 1, wherein the indentation extends a width on the sidewall at a vertical height between 0.254 mm and 0.508 mm.

10. The electrochemical cell according to claim 1, wherein the catalytic electrode casing has a thickness that ranges from 0.10 mm to 0.25 mm, and wherein the indentation has a maximum depth relative to the sidewall outer surface above and below the indentation of from 0.0127 mm to 0.0762 mm.

11. The electrochemical cell according to claim 10, wherein the maximum depth is no more than 0.0508 mm.

12. The electrochemical cell according to claim 1, wherein the catalytic electrode comprises a catalytic material for reducing oxygen or for generating hydrogen or oxygen, and wherein the counter electrode comprises zinc.

13. The electrochemical cell according to claim 12, wherein the counter electrode is a gelled electrode comprising an aqueous electrolyte, a gelling agent and zinc, and wherein the catalytic electrode comprises carbon, a binder, and manganese oxide.

14. The electrochemical cell according to claim 1, wherein the cell is a hydrogen generating cell and the catalytic electrode includes at least one layer for excluding oxygen from the cell located between the aperture and the catalytic electrode.

15. The electrochemical cell according to claim 13, wherein the cell is free of added mercury.

16. An electrochemical cell, comprising:
a catalytic electrode comprising a current collector screen and at least one membrane layer that is air permeable and electrolyte impermeable;
a counter electrode;
a separator disposed between the counter electrode and the catalytic electrode;
a first casing in electrical contact with the catalytic electrode, said first casing having an open end, a closed end comprising a base having an aperture, and a sidewall extending between the closed end and the open end, said sidewall comprising an inner surface and an outer surface;
a second casing in electrical contact with the counter electrode; and
an insulating seal member disposed between the first and second casings;
wherein:
the cell is a cylindrical or button cell;
the sidewall inner surface has radii measured from a central vertical axis of the cell including a first radius that is in contact with a peripheral portion of the current collector screen, a second radius below the first radius and adjacent a portion of the at least one membrane layer of the catalytic electrode, and a third radius above the first radius; and
the first radius is smaller than the second radius and the third radius.

17. The electrochemical cell according to claim 16, wherein the counter electrode is a gelled electrode comprising an electrolyte, a gelling agent and zinc, wherein the catalytic electrode comprises carbon, a binder, and manganese oxide, and wherein the at least one membrane layer is located between the aperture and the current collector screen.

18. The electrochemical cell according to claim 16, wherein the at least one membrane layer has a peripheral edge located vertically between the first casing base and a surface of the first radius.

19. The electrochemical cell according to claim 16, wherein the first radius is adjacent an indentation in the outer surface of the first casing sidewall, and wherein the indentation extends essentially horizontally on the sidewall at a vertical height between 0.254 mm and 0.508 mm from a base of the first casing.

20. The electrochemical cell according to claim 19, wherein the indentation has a maximum depth relative to the sidewall outer surface above and below the indentation of from 0.0127 mm to 0.0762 mm.

21. The electrochemical cell according to claim 16, wherein the first radius is formed by two or more segments separated by at least one gap, with the two or more segments located in a plane also containing at least a portion of the catalytic electrode current collector screen.

22. The electrochemical cell according to claim 16, wherein the first radius is continuous and extends around a periphery of the catalytic electrode in a plane also containing at least a portion of the catalytic electrode current collector screen.

23. An electrochemical cell, comprising:
a catalytic electrode comprising a current collector screen, and at least one membrane layer that is air permeable and electrolyte impermeable;
a counter electrode;
a separator disposed between the counter electrode and the catalytic electrode;
a first casing in electrical contact with the catalytic electrode, said first casing having an open end, a closed end comprising a base having an aperture, and a sidewall extending between the closed end and the open end, said sidewall comprising an inner surface and an outer surface;
a second casing in electrical contact with the counter electrode; and
an insulating seal member disposed between the first and second casings;
wherein:
the sidewall has an area beaded inwardly relative to the sidewall above and below the beaded area;
the beaded area is adjacent to and contacting an edge of the current collector screen; and
a portion of the at least one membrane layer of the catalytic electrode is located closer to the first casing base than the current collector screen.

24. The electrochemical cell according to claim 23, wherein the cell is a cylindrical cell or button cell, wherein an apex of the beaded area on the sidewall inner surface is in contact with a portion of the catalytic electrode current collector screen.

25. The electrochemical cell according to claim 23, wherein the inwardly beaded area is a continuous inwardly beaded area that extends around a periphery of the catalytic electrode casing in a plane also containing at least a portion of the catalytic electrode current collector screen.

26. The electrochemical cell according to claim 23, wherein the inwardly beaded area comprises two or more segments separated by at least one gap, with the two or more inwardly beaded segments located in a plane also containing at least a portion of the catalytic electrode current collector screen.

27. The electrochemical cell according to claim 24, wherein the inwardly beaded area extends on the sidewall at a vertical height between 0.254 mm and 0.508 mm from a base of the first casing.

28. The electrochemical cell according to claim 27, wherein the inwardly beaded area has a maximum depth relative to the sidewall outer surface above and below the inwardly bead area of from 0.0127 mm to 0.0762 mm.

29. The electrochemical cell according to claim 28, wherein the counter electrode is a gelled electrode comprising an electrolyte, a gelling agent and zinc, wherein the catalytic electrode comprises carbon, a binder, and manganese oxide, and wherein the at least one membrane layer of the catalytic electrode has a greater diameter than the current collector screen.

30. A method for improving electrode to casing contact, comprising the steps of:
providing an electrochemical cell having a positive casing having an open end, a closed end comprising a base, and a sidewall extending between the closed end and the open end;
disposing a catalytic electrode in the catalytic electrode casing, the catalytic electrode comprising a current collector screen having a major surface extending substantially perpendicular to the sidewall; and
forming an indentation in an outer surface of the sidewall laterally adjacent the current collector screen of the catalytic electrode that creates a projection on an inner surface of the sidewall that contacts the current collector screen.
